(19) United States
(12) Patent Application Publication
(10) Pub. No.: US 2020/0192973 A1
(43) Pub. Date: Jun. 18, 2020

(54) CLASSIFICATION OF NON-TIME SERIES DATA

(71) Applicant: SAP SE, Walldorf (DE)

(72) Inventor: Balaji Raghunathan, Bengaluru (IN)

(21) Appl. No.: 16/221,840

(22) Filed: Dec. 17, 2018

(51) Int. Cl. G06F 17/22; G06N 3/04; G06N 20/00; G06F 17/16; G06F 16/31; G06F 16/35

(52) U.S. Cl. CPC G06F 17/2276; G06N 3/04; G06F 16/35; G06F 17/16; G06F 16/313; G06N 20/00

(57) ABSTRACT

Methods, systems, and apparatus, including computer programs encoded on a computer storage medium, to determine the meaning a block or text. In one aspect, a method includes receiving textual data from an application and processing the textual data through a trained neural network to generate a vector space of an n-dimensional shape. Each unique word in the textual data is assigned a corresponding vector representation in the vector space, where the vector space includes clusters of the vector representations for the unique words in the textual data that are synonymous. A normalized sum based on the vector representation in the vector space is determined, where the normalized sum represents a full dimensionality of the textual data. A contextual meaning for the textual data based on the normalized sum is provided to the application through a simple neural network classification.

### BACKGROUND

The subject matter of Natural Language Processing (NLP) includes the study of how computer modeling can be employed to understand and manipulate natural language. In general, NLP models can be built based on how humans understand and use language. These models may be employed for analyzing and representing texts at one or more levels of linguistic analysis for the purpose of achieving language processing for a range of tasks or applications. Natural language can be of any language, mode, or genre in the form of texts. These texts can be oral or written, and used by humans to communicate with one another. For example, such text may be gathered from actual usage and processed to perform useful tasks.

### SUMMARY

Implementations of the present disclosure are generally directed to a system that may employ a trained model to find the contextual neighborhood to determine a meaning of a provided text block or document. The meaning can be employed by the described system as an actual representation of the product, spec or topic of the input, for example, a product code, a sentiment, a rating, or others.

One example method includes receiving textual data from an application and processing the textual data through a trained neural network to generate a vector space of an n-dimensional shape. Each unique word in the textual data is assigned a corresponding vector representation in the vector space, where the vector space includes clusters of the vector representations for the unique words in the textual data that are synonymous. A normalized sum based on the vector representation of words in the vector space is determined, where the sum, normalized, represents a full dimensionality of the textual data/document. A contextual meaning for the textual data/document based on the normalized sum is provided to the application.

Implementations can optionally include one or more of the following features. In some instances, each of the vector representations comprise a floating point number.

In some instances, the neural network is a shallow, two-layer neural networks having been trained to reconstruct linguistic contexts of words.

In some instances, the neural network is a fully connected neural networks (RNN).

In some instances, an n-gram model may be employed to make the input feed more convolutional (CNN) and that would require the input to be treated as a 3D, rather than a 2D, before it is considered for a normalized summary.

In some instances, the normalized sum could more generally mean, a normalized summary, derived by other feasible mathematical representations, like normalized means, or normalized product of the individual input features, words in this case, of the document.

In some instances, the vector space includes several hundred dimensions.

In some instances, the vector representations are positioned in the vector space such that words that share a common context in the textual data are located in close proximity to one another in the vector space.

In some instances, the textual data includes multiple languages.

In some instances, the textual data includes symbols, and wherein each of the symbols represents a word or a concept.

In some instances, the method may further include, before determining the normalized sum, consolidating the clusters, and then matching each of the consolidated clusters to a label. In some of those instances, the consolidated clusters are provided to a fully connected activation layer and to an output layer for both training.

In some instances, the application is deployed to a client device.

In some instances, the textual data is received as a corpus or a specification.

Particular implementations of the subject matter described in this disclosure can be implemented so as to realize one or more of the following advantages. The described textual classification system provides an analysis of speech or textual content and/or messages which do not follow any standard grammatical dogma or word precedence rules. In some use cases, such as drug review analysis and classification where drug feedback is collection—both from patient physical condition parameters and patient responses—the present solution allows researchers and analysts to analyze and rate the efficacy of the particular drug or drugs. The solution can also be used for product evaluation in other use cases, and can evaluate the product from different product attributes, such as pricing, segment, reviews, feedback, and other parameters. For example, wine quality can be evaluated from different sets of parameters as opposed to merely a single rating consideration.

Similar operations and processes may be performed in a system comprising at least one process and a memory communicatively coupled to the at least one processor where the memory stores instructions that when executed cause the at least one processor to perform the operations. Further, a non-transitory computer-readable medium storing instructions which, when executed, cause at least one processor to perform the operations may also be contemplated. In other words, while generally described as computer-implemented software embodied on tangible, non-transitory media that processes and transforms the respective data, some or all of the aspects may be computer implemented methods or further included in respective systems or other devices for performing this described functionality. The details of these and other aspects and embodiments of the present disclosure are set forth in the accompanying drawings and the description below. Other features, objects, and advantages of the disclosure will be apparent from the description and drawings, and from the claims.

It is appreciated that methods in accordance with the present disclosure can include any combination of the aspects and features described herein. That is, methods in accordance with the present disclosure are not limited to the combinations of aspects and features specifically described herein, but also may include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 depicts an example graph representation 100 of words in a reduced three-dimensional space.

FIG. 2 depicts a justification and graph representation that includes clusters and an overall normalized sum.

FIG. 3 depicts a flow diagram of an example process that may be implemented by an implementation of the present disclosure.

FIG. 4 depicts a block diagram of an exemplary computer system that can be employed to execute implementations of the present disclosure.

### DETAILED DESCRIPTION

Implementations of the present disclosure are generally directed to a textual classification system. More particularly, implementations of the present disclosure are directed to a system that may employ a neural network to determine the meaning of words or groupings of words within the context of provided textual data, such as a text corpus or specification.

NLP may include the modeling of text to understand both the words as well as the context of the words individually, words may not provide enough information to determine a proper meaning. As such, a model employed within an NLP system that ties words together with the surrounding words in a block of text within, for example, a data file can provide for a better understanding as to the word's context.

A block of text may include patterns that can be broadly classified as time-series or non-time series data. Time-series data may include sequential data where non-time series data may include largely non-sequential or arbitrary data. For example, a sentiment analysis of texts, such as reports, journals, and novels may follow a time-series pattern in the sense that the words themselves follow a precedence as governed by the grammar and the language dictionary. The same applies to stock-price prediction problems, which have a precedent of the previous time period predictions and socio-economic conditions. Whereas, non-sequential data may not follow a pattern as the occurrence of words may not follow a precedent; however, the words and attributes may collectively provide a meaning of the context. Furthermore, non-sequential data may include words and/or symbols that are not a part of any standard language dictionary, but may be some enterprise convention language or industry specification that still collectively conveys the classification (e.g., a label in machine learning terminology). One such scenario includes a product or part specification, which is discussed below as an example context for the described system; however, the described system is not limited to such a context, but may be employed to classify any speech or textual data that follows a non-time series/non-sequential pattern.

In some instances, there is a need to classify items based on product specification. The product in question does not need to be a finished end product, but may also be a raw materials, a commodity for processing or running a business, spare parts, office equipment, maintenance equipment, or other items which could be ordered for running an enterprise or used as part of manufacturing. One reason for the described solution is that enterprises need spend information and visibility into how their budgets are consumed, allowing them to classify purchases and better reconcile their spend for subsequent quarters. As spend information is an ad hoc language and is not in any formatted grammatical order or language description, the present solution can allow for a better, clearer description. For example, the description of an invoice could be an ad hoc language native to an enterprise or department. The language would not necessarily be part of any standard language dictionary or natural language toolkit. Using the solution described herein, the items included therein could be analyzed and classified for better understanding.

The described textual classification system may employ machine learning to train an algorithm(s) with various textual data inputs. The subject matter of machine learning includes the study of computer modeling of learning processes in their multiple manifestations. In general, learning processes include various aspects, such as the acquisition of new declarative knowledge; the devilment of motor and cognitive skills through instruction or practice; the organization of new knowledge into general, effective representations; and the discovery of new facts and theories through observation and experimentations. For example, implementations of the present disclosure may employ a neural network that includes a group of algorithms used for machine learning. These neural networks can be trained to model the provided data.

Types of neural networks includes feed forward neural networks (FFNN), Long Short-Term Memory (LSTM) neural networks, convolutional neural networks (CNNs), and recurrent neural networks (RNNs). FFNNs feed information from the front to the back (input and output, respectively). LSTM neural networks include one or more LSTM layers while CNNs include one or more CNN layers and, optionally, one or more fully connected layers. RNNs are FFNNs with a time twist: they are not stateless; they have connections between passes, connections through time. Neurons are fed information not just from the previous layer but also from themselves from the previous pass. In some implementations, an RNN may be designed to recognize sequences, such as, a speech signal or a text.

In view of the forgoing, the described textual classification system provides for the reliable and accurate determination of word meaning based on the textual context. In some implementations, the described system may employ a neural network trained with textual data. Once trained, the neural network may be provided with other textual data to determine, for example, the meaning of words or groupings of words within the context of the text. For example, the words within a block of text may be in an ad hoc language, which can include a mix of languages with various symbols, such as emojis, mixed throughout the text. Moreover, enterprise data may also include unconventional expression, such as abbreviations, spelling mistakes, ad hoc synonyms, and so forth. For Example, Johnson & Johnson can appear as “J&J,” “JJ,” or “J&J Inc.”

In some implementations, the described textual classification system may employ a clustering analysis of textual data. Cluster analysis or clustering may include the task of grouping a set of objects in such a way that the objects in the same group (called a cluster) are more similar (in some sense) to each other than to those in other groups (clusters). Additionally, the words that convey a similar meaning across languages can be clustered together. For example, “Com.,” “Ltd.,” and “Inc.” may all be synonymous for “GmbH” in a primarily German document, which can be clustered by the described system. In some implementations, words with similar meanings that are contextually similar may be clustered by the described system both when training the neural network and as the trained neural network model processes textual data.

In statistics, a dimension is a structure that categorizes facts and measures, and dimensionality may refer to how many attributes a dataset (e.g., a corpus of text) has. In some implementations, the described textual classification system employs embedding models, such as Word2vec, to produce the above-described clusters or word embeddings. Such models may be, for example, shallow, two-layer neural networks that are trained to reconstruct linguistic contexts of words. The models may take as input a corpus of text and produce a vector space, typically of several hundred dimensions, where each unique word in the corpus is assigned a corresponding vector representation in the vector space. As such, a dictionary of words may be generated in the process. In some implementations, word vectors may be positioned in the vector space such that words that share common contexts in the corpus are located in close proximity to one another in the vector space. The end result of this clustering includes clusters of similar words in an n-dimensional shape. Each of these clusters of words can be thought of as synonymous to other words in the same cluster.

In some implementations, dimensionality reduction techniques, such as t-Distributed Stochastic Neighbor Embedding (t-SNE), are applied to the vector space. A dimensionality reduction technique can refer to the process of converting a set of data having vast dimensions into data with lesser dimensions (e.g., 3) ensuring that it conveys similar information concisely.

These techniques are typically used while solving machine-learning problems to obtain better features for a classification or regression task.

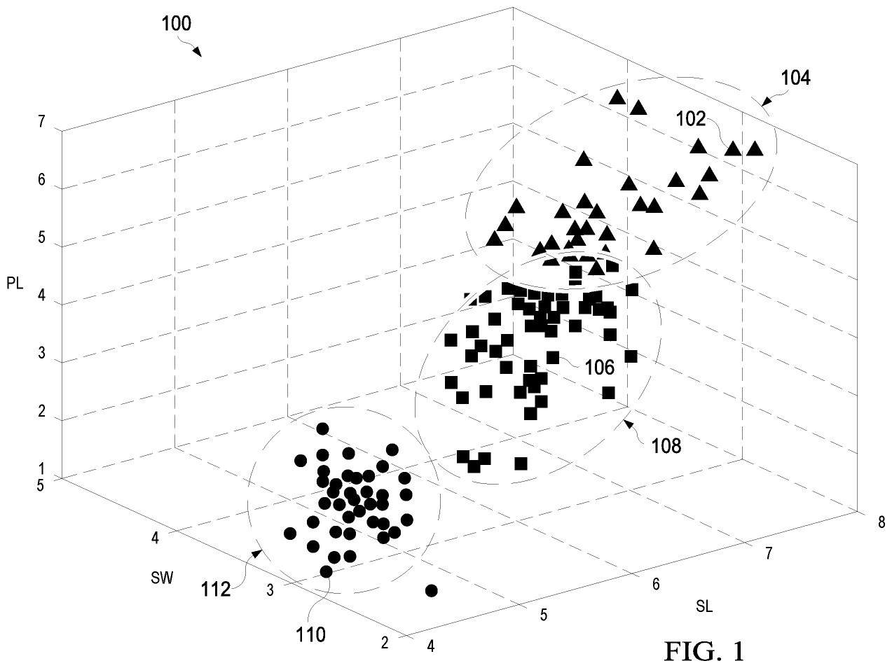

FIG. 1 depicts an example graph representation 100 of words in a reduced three-dimensional space. The graphical representation 100 includes words (dots) 102 that represent various words processed from, for example, textual data. The words 102 are spaced according to their determined meaning in the 3D space. The graphical representation 100 also includes clusters or groupings 104 of the words 102.

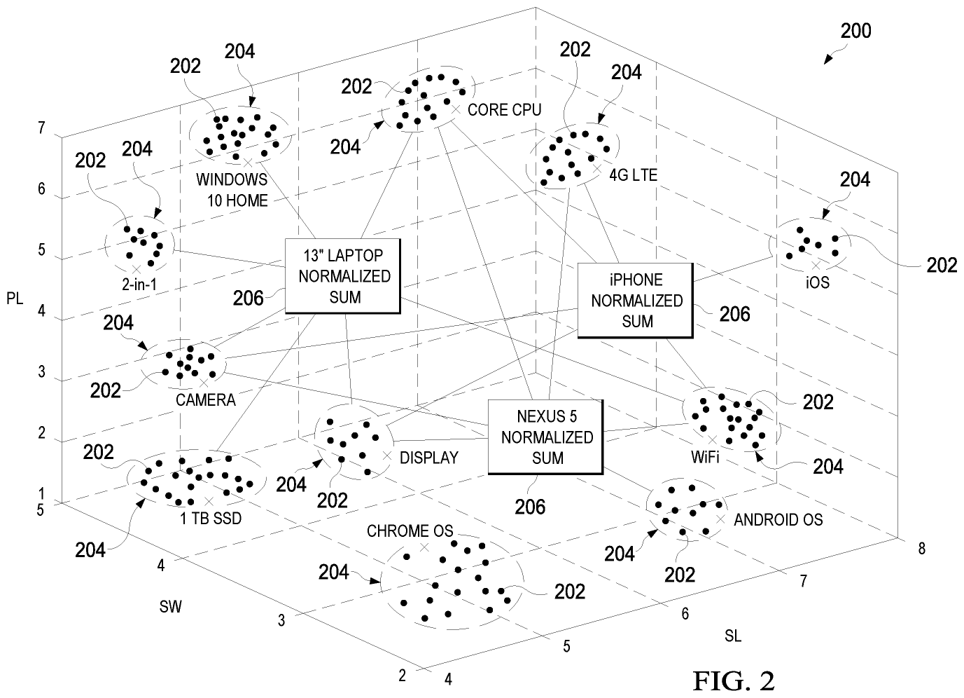

In some implementations, the described system consolidates the clusters or word embeddings to determine the gist of each. This information may be matched to a label (see, e.g., FIG. 2). The consolidated output of the embeddings may be fed to a fully connected activation layer and to an output layer (e.g., within a neural network architecture) for both training of the neural network and processing by a trained neural network. For example, this output can be employed for training to evaluate the cross entropy loss and accuracy.

In some implementations, an RNN or a variant may be employed to perform the consolidation or the embeddings. RNNs work well with sequential time-series data. In some implementations, a CNN may be employed to convolute over n-gram (a contiguous sequence of n items from a given sample of text or speech) of word embeddings. In some implementations, a simpler and efficient method to consolidate the embeddings, such as based on the normalized sum of the embeddings of the words in the specification, can be employed. In such implementations, the sum can be fed to a fully connected neural network layer.

As an example, a laptop specification may include the terms “Lenovo V330 15” CPU: Intel Core i5-7200U. GPU: Intel HD Graphics 620. Display: 15.6″, Full HD (1920×1080), TN. RAM: 8 GB.” Considering that each input in this data point is a word (1-gram model) and each word adds to the specification of the laptop. This specification may be split by the described system as space separated words to approximately 20-25 words (e.g., data points), each of which may be provided with an attached embedding representation. For a 500-dimension vector embedding for each word with these 20-25 words in the specification, the input may be a 20×500 dimension input matrix. In some examples, the normalized sum would reduce this to 1×500. This vector specification would tilt toward the output label and may be represented as sum of word embeddings x/sqrt(sum(square(x))), or:

Σᵢ₌₀ⁿsᵢ/\sqrt{Σᵢ₌₀ⁿxᵢ²} (1)

which can be employed to determine the normalized sum for the specification subject matter (in this example, the term “laptop”; see FIG. 2). As noted, xᵢ represents the embeddings for word ‘i’ in the document.

FIG. 2 depicts a justification and graph representation 200 that includes clusters 204, exact points 202, and overall normalized sum or summary values 206. The normalized summary or sum of a particular set of clusters and points can point to the particular overall summary value 206, which can identify a particular product or term based on a particular set of selected clusters or exact points within a cluster. In some instances, particular components may be more granularly identified in the graph representation 200, such that identifying a particular set of clusters can identify a more specific model, or identifying different clusters may result in an identification of a specific model from a plurality of models. As illustrated, the exact points may identify particular types or instances within a cluster, such as the core CPU cluster. One exact point may be for a dual-core CPU, while other exact points may be for other types of CPUs, such as dual-core, single-core, or others. Similarly, in some clusters, points around or within a particular cluster may be contextual synonyms or translations of a particular term. For example, the cluster around “Camera” may include “ [symbol] ”in Chinese, or ‘Kamera’ in German, as well as other English or other language synonyms and translations. In some instances, the points may also include other alternative spellings or common misspellings of a particular term or phrase. In some implementations, each of the clusters 204 includes data points of the processed words (e.g., determined from a processed corpus) clustered contextually. In some implementations, this vector may be fed to a model to classify non-time series data. For example, when a product description is received to be classified, the vector embeddings for each word can be selected and used to calculate a normalized sum or summary for a particular product. The normalized sum can be used subsequently for classification. Such a model may include a fully connected two layer neural network with, for example, one hidden layer and an output layer representing the number of labels. For example, the cluster 204 for core CPUs depicts how the described textual classification system reduces the number of dimensions for a received dataset down to 3 (e.g., represented by the x, y, and z axes). In some implementations, the dimensions with a dataset can be reduced through a dimensionality reduction technique.

As illustrated in FIG. 2, different combinations of clusters 204 can be used to identify particular products. For a 13″ laptop, a combination of clusters 204 related to a core CPU, Windows 10 Home operating system, “2-in-1” related to a laptop or tablet, a display, and 1 TB SSD may be used to partially define the product. For a Nexus 5 device, a combination of Android OS, a display, WiFi, 4G LTE, and a core CPU may be used. Further, for an iPhone, Apple's iOS, WiFi, 4G LTE, a display, and a core CPU are used to identify the product. These combined descriptors can be used to identify and summarize, using Equation 1 above, particular products based on the clustered elements.

In some implementations, a dimensionality is determined for each cluster. This dimensionality can be represented by a floating point number (e.g., the vector of the floating point representation for the meaning of the word). A sum, normalized, can be determined for an entire data set (e.g., a corpus or specification regarding a laptop) based on the floating point numbers determined for the identified words within the provided data set (e.g., the laptop specification). This sum may represent a single value for the full dimensionality of the data set or document.

In some implementations, the described textual classification system may employ a trained model to find the contextual neighborhood of words in the same context (as the training data) to determine the meaning of a provided text block or document. The meaning can be employed by the described system as an actual representation of the product or topic of the input. This data (e.g., determined mean values) can also be employed by the described system to feed/train a neural network. The trained model can be employed with poor data points (e.g., those with few words, such as an invoice, or a single word) to determine meaning and context. In other examples, a corpus may be provided to the described textual classification system through an application, such as a mobile or web application deployed to and/or executed by a client device. In such examples, the textual classification system may determine a normalized sum for the corpus to determine a contextual meaning for the corpus, which can be provided back to the application as output.

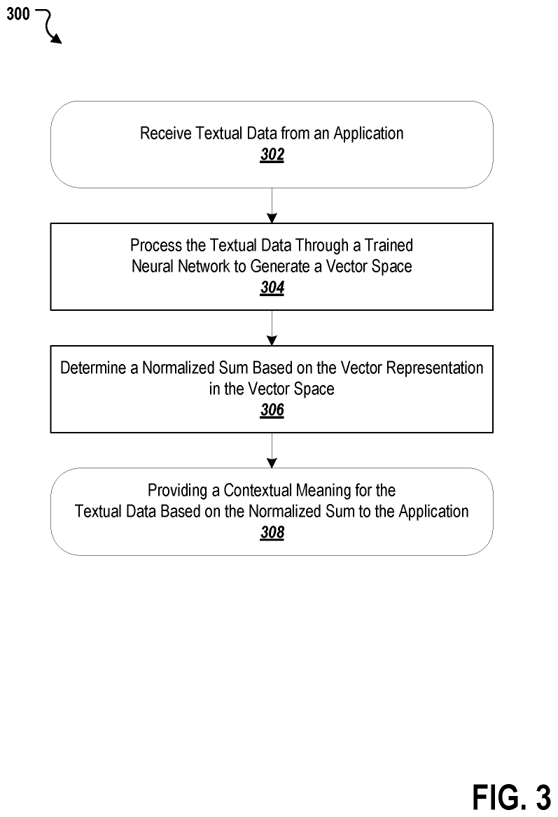

FIG. 3 depicts a flow diagram of an example process 300 that may be implemented by an implementation of the present disclosure. For clarity of presentation, the description that follows generally describes this process in the context of FIGS. 1, 2, and 4. However, it will be understood that this process may be performed, for example, by any other suitable system, environment, software, and hardware, or a combination of systems, environments, software, and hardware as appropriate. In some implementations, various operations of process 300 can be run in parallel, in combination, in loops, or in any order.

At 302, textual data of the text from an application is received. In some implementations, the application is deployed to a client device. In some implementations, the textual data includes multiple languages. In some implementations, the textual data includes symbols, and wherein each of the symbols represents a word or a concept. In some implementations, the textual data is received as a corpus or a specification. From 302, the process 300 proceeds to 304.

At 304, the textual data is processed through a trained neural network to generate a vector space of an n-dimensional shape. Each unique word in the textual data is assigned a corresponding vector representation in the vector space, and the vector space includes clusters of the vector representations for the unique words in the textual data that are synonymous. In some implementations, each of the vector representations comprise a floating-point number. In some implementations, the neural network is a shallow, two-layer neural networks having been trained to reconstruct linguistic contexts of words. In some implementations, the neural network is an RNN. In some implementations, the vector space includes several hundred dimensions. In some implementations, the vector representations are positioned in the vector space such that words that share a common context in the textual data are located in close proximity to one another in the vector space. From 304, the process 300 proceeds to 306.

At 306, a normalized sum is determined based on the vector representation in the vector space. The normalized sum represents a full dimensionality of the textual data or document under classification. In some implementations, the consolidated clusters are provided to a fully connected activation layer and to an output layer for training. From 306, the process 300 proceeds to 308.

At 308, a contextual meaning for the textual data based on the normalized sum is provided to the application. From 308, the process 300 ends.

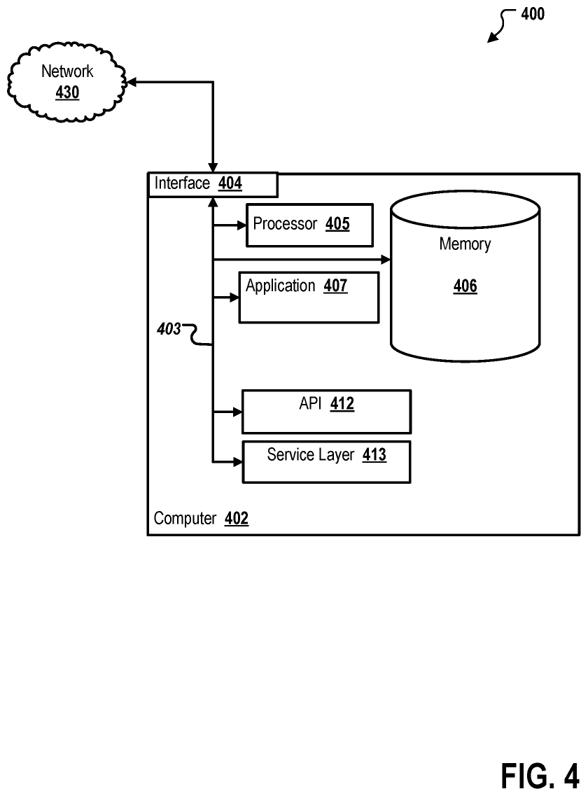

FIG. 4 depicts a block diagram of an exemplary computer system 400 used to provide computational functionalities associated with described algorithms, methods, functions, processes, flows, and procedures as described in the instant disclosure, according to an implementation. The illustrated computer 402 is intended to encompass any computing device such as a server, desktop computer, laptop or notebook computer, wireless data port, smart phone, personal data assistant (PDA), tablet computing device, one or more processors within these devices, or any other suitable processing device, including both physical or virtual instances (or both) of the computing device. Additionally, the computer 1402 may comprise a computer that includes an input device, such as a keypad, keyboard, touch screen, or other device that can accept user information, and an output device that conveys information associated with the operation of the computer 402, including digital data, visual, or audio information (or a combination of information), or a graphical user interface (GUI).

The computer 402 can serve in a role as a client, network component, a server, a database or other persistency, or any other component (or a combination of roles) of a computer system for performing the subject matter described in the instant disclosure. The illustrated computer 402 is communicably coupled with a network 430. In some implementations, one or more components of the computer 402 may be configured to operate within environments, including cloud-computing-based, local, global, or other environment (or a combination of environments).

At a high level, the computer 402 is an electronic computing device operable to receive, transmit, process, store, or manage data and information associated with the described subject matter. According to some implementations, the computer 402 may also include or be communicably coupled with an application server, e-mail server, web server, caching server, streaming data server, business intelligence (BI) server, or other server (or a combination of servers).

The computer 402 can receive requests over network 430 from a client application (for example, executing on another computer 402) and responding to the received requests by processing the said requests in an appropriate software application. In addition, requests may also be sent to the computer 402 from internal users (for example, from a command console or by other appropriate access method), external or third parties, other automated applications, as well as any other appropriate entities, individuals, systems, or computers.

Each of the components of the computer 402 can communicate using a system bus 403. In some implementations, any or all of the components of the computer 402, both hardware or software (or a combination of hardware and software), may interface with each other or the interface 404 (or a combination of both) over the system bus 403 using an API 412 or a service layer 413 (or a combination of the API 412 and service layer 413). The API 412 may include specifications for routines, data structures, and object classes. The API 412 may be either computer-language independent or dependent and refer to a complete interface, a single function, or even a set of APIs. The service layer 413 provides software services to the computer 402 or other components (whether or not illustrated) that are communicably coupled to the computer 402. The functionality of the computer 402 may be accessible for all service consumers using this service layer. Software services, such as those provided by the service layer 413, provide reusable, defined business functionalities through a defined interface. For example, the interface may be software written in JAVA, C++, python, R, or other suitable languages providing data in extensible markup language (XML) format or other suitable formats. While illustrated as an integrated component of the computer 402, alternative implementations may illustrate the API 412 or the service layer 413 as stand-alone components in relation to other components of the computer 402 or other components (whether or not illustrated) that are communicably coupled to the computer 402. Moreover, any or all parts of the API 412 or the service layer 413 may be implemented as child or sub-modules of another software module, enterprise application, or hardware module without departing from the scope of this disclosure.

The computer 402 includes an interface 404. Although illustrated as a single interface 404 in FIG. 4, two or more interfaces 404 may be used according to particular needs, desires, or particular implementations of the computer 402. The interface 404 is used by the computer 402 for communicating with other systems in a distributed environment that are connected to the network 430 (whether illustrated or not). Generally, the interface 404 comprises logic encoded in software or hardware (or a combination of software and hardware) and operable to communicate with the network 430. More specifically, the interface 404 may comprise software supporting one or more communication protocols associated with communications such that the network 430 or interface's hardware is operable to communicate physical signals within and outside of the illustrated computer 402.

The computer 402 includes a processor 405. Although illustrated as a single processor 405 in FIG. 4, two or more processors may be used according to particular needs, desires, or particular implementations of the computer 402. Generally, the processor 405 executes instructions and manipulates data to perform the operations of the computer 402 and any algorithms, methods, functions, processes, flows, and procedures as described in the instant disclosure.

The computer 402 also includes a memory 406 that holds data for the computer 402 or other components (or a combination of both) that can be connected to the network 430 (whether illustrated or not). For example, memory 406 can be a database storing data consistent with this disclosure. Although illustrated as a single memory 406 in FIG. 4, two or more memories may be used according to particular needs, desires, or particular implementations of the computer 402 and the described functionality. While memory 406 is illustrated as an integral component of the computer 402, in alternative implementations, memory 406 can be external to the computer 402.

The application 407 is an algorithmic software engine providing functionality according to particular needs, desires, or particular implementations of the computer 402, particularly with respect to functionality described in this disclosure. For example, application 407 can serve as one or more components, modules, applications, etc. Further, although illustrated as a single application 407, the application 407 may be implemented as multiple applications 407 on the computer 402. In addition, although illustrated as integral to the computer 402, in alternative implementations, the application 407 can be external to the computer 402.

There may be any number of computers 402 associated with, or external to, a computer system that includes computer 402, with each computer 402 communicating over network 430. Further, the term “client,” “user,” and other appropriate terminology may be used interchangeably as appropriate without departing from the scope of this disclosure. Moreover, this disclosure contemplates that many users may use one computer 402, or that one user may use multiple computers 402.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Implementations of the subject matter described in this specification can be implemented as one or more computer programs, that is, one or more modules of computer program instructions encoded on a tangible, non-transitory, computer-readable computer-storage medium for execution by, or to control the operation of, data processing apparatus. Alternatively or in addition, the program instructions can be encoded on an artificially generated propagated signal, for example, a machine-generated electrical, optical, or electromagnetic signal that is generated to encode information for transmission to suitable receiver apparatus for execution by a data processing apparatus. The computer-storage medium can be a machine-readable storage device, a machine-readable storage substrate, a random or serial access memory device, or a combination of computer-storage mediums.

The terms “data processing apparatus,” “computer,” or “electronic computer device” (or equivalent as understood by one of ordinary skill in the art) refer to data processing hardware and encompass all kinds of apparatus, devices, and machines for processing data, including by way of example, a programmable processor, a computer, or multiple processors or computers. The apparatus can also be or further include special purpose logic circuitry, for example, a central processing unit (CPU), a field programmable gate array (FPGA), or an application-specific integrated circuit (ASIC). In some implementations, the data processing apparatus or special purpose logic circuitry (or a combination of the data processing apparatus or special purpose logic circuitry) may be hardware- or software-based (or a combination of both hardware- and software-based). The apparatus can optionally include code that creates an execution environment for computer programs, for example, code that constitutes processor firmware, a protocol stack, a database management system, an operating system, or a combination of execution environments. The present disclosure contemplates the use of data processing apparatuses with or without conventional operating systems, for example LINUX, UNIX, WINDOWS, MAC OS, ANDROID, IOS or any other suitable conventional operating system.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other units suitable for use in a computing environment. A computer program may, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network. While portions of the programs illustrated in the various figures are shown as individual modules that implement the various features and functionality through various objects, methods, or other processes, the programs may instead include a number of sub-modules, third-party services, components, libraries, and such, as appropriate. Conversely, the features and functionality of various components can be combined into single components as appropriate.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, for example, a CPU, an FPGA, or an ASIC.

Computers suitable for the execution of a computer program can be based on general or special purpose microprocessors, both, or any other kind of CPU. Generally, a CPU will receive instructions and data from a read-only memory (ROM) or a random access memory (RAM) or both. The essential elements of a computer are a CPU for performing or executing instructions and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable storage device, for example, a universal serial bus (USB) flash drive, to name just a few.

Computer-readable media (transitory or non-transitory, as appropriate) suitable for storing computer program instructions and data include all forms of non-volatile memory, media and memory devices, including by way of example semiconductor memory devices, for example, erasable programmable read-only memory (EPROM), electrically erasable programmable read-only memory (EEPROM), and flash memory devices; magnetic disks, for example, internal hard disks or removable disks; magneto-optical disks; and Compact Disc Read-Only Memory (CD-ROM), Digital Versatile Disk (DVD)+/−R, DVD-RAM, and DVD-ROM disks. The memory may store various objects or data, including caches, classes, frameworks, applications, backup data, jobs, web pages, web page templates, database tables, repositories storing dynamic information, and any other appropriate information including any parameters, variables, algorithms, instructions, rules, constraints, or references thereto. Additionally, the memory may include any other appropriate data, such as logs, policies, security or access data, reporting files, as well as others. The processor and the memory can be supplemented by, or incorporated in, special purpose logic circuitry.

To provide for interaction with a user, implementations of the subject matter described in this specification can be implemented on a computer having a display device, for example, a CRT (cathode ray tube), LCD (liquid crystal display), LED (Light Emitting Diode), or plasma monitor, for displaying information to the user and a keyboard and a pointing device, for example, a mouse, trackball, or trackpad by which the user can provide input to the computer. Input may also be provided to the computer using a touchscreen, such as a tablet computer surface with pressure sensitivity, a multi-touch screen using capacitive or electric sensing, or other type of touchscreen. Other kinds of devices can be used to provide for interaction with a user as well; for example, feedback provided to the user can be any form of sensory feedback, for example, visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A GUI may be used in the singular or the plural to describe one or more graphical user interfaces and each of the displays of a particular graphical user interface. Therefore, a GUI may represent any graphical user interface, including but not limited to, a web browser, a touch screen, or a command line interface (CLI) that processes information and efficiently presents the information results to the user. In general, a GUI may include a plurality of UI elements, some or all associated with a web browser, such as interactive fields, pull-down lists, and buttons operable by the business suite user. These and other UI elements may be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a LAN, a radio access network (RAN), a metropolitan area network (MAN), a WAN, Worldwide Interoperability for Microwave Access (WIMAX), a wireless local area network (WLAN) using, for example, 802.11 a/b/g/n or 802.20 (or a combination of 802.11x and 802.20 or other protocols consistent with this disclosure), all or a portion of the Internet, or any other communication system or systems at one or more locations (or a combination of communication networks). The network may communicate with, for example, Internet Protocol (IP) packets, Frame Relay frames, Asynchronous Transfer Mode (ATM) cells, voice, video, data, or other suitable information (or a combination of communication types) between network addresses.

The computing system can include clients and servers. A client and server are generally remote from each other and typically interact through a communication network. The relationship of client and server arises by virtue of computer programs running on the respective computers and having a client-server relationship to each other.

In some implementations, any or all of the components of the computing system, both hardware or software (or a combination of hardware and software), may interface with each other or the interface using an API or a service layer (or a combination of API and service layer). The API may include specifications for routines, data structures, and object classes. The API may be either computer language independent or dependent and refer to a complete interface, a single function, or even a set of APIs. The service layer provides software services to the computing system. The functionality of the various components of the computing system may be accessible for all service consumers using this service layer. Software services provide reusable, defined business functionalities through a defined interface. For example, the interface may be software written in JAVA, C++, python, R or other suitable language providing data in extensible markup language (XML) format or other suitable format. The API or service layer (or a combination of the API and the service layer) may be an integral or a stand-alone component in relation to other components of the computing system. Moreover, any or all parts of the service layer may be implemented as child or sub-modules of another software module, enterprise application, or hardware module without departing from the scope of this disclosure.

While this specification contains many specific implementation details, these should not be construed as limitations on the scope of any invention or on the scope of what may be claimed, but rather as descriptions of features that may be specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described earlier as acting in certain combinations and even initially claimed as such, one or more features from a claimed combination can in some cases be excised from the combination, and the claimed combination may be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the implementations described earlier should not be understood as requiring such separation or integration in all implementations, and it should be understood that the described program components and systems can generally be integrated together in a single software product or packaged into multiple software products. Accordingly, the earlier description of example implementations does not define or constrain this disclosure. Other changes, substitutions, and alterations are also possible without departing from the spirit and scope of this disclosure.

Furthermore, any claimed implementation described later is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method being executed by one or more processors, the method comprising:
receiving textual data from an application;
processing the textual data through a trained neural network to generate a vector space of an n-dimensional shape, wherein each unique word in the textual data is assigned a corresponding vector representation in the vector space, wherein the vector space includes clusters of the vector representations for the unique words in the textual data that are synonymous;
determining a normalized sum based on the vector representation in the vector space, wherein the normalized sum represents a full dimensionality of the textual data or document; and
providing, to the application, a contextual meaning for the textual data based on the sum.

2. The computer-implemented method of claim 1, wherein each of the vector representations comprise a floating point number.

3. The computer-implemented method of claim 1, wherein the neural network is a shallow, two-layer neural networks having been trained to reconstruct linguistic contexts of words.

4. The computer-implemented method of claim 1, wherein the neural network is a fully connected neural networks.

5. The computer-implemented method of claim 1, wherein the vector space includes several hundred dimensions.

6. The computer-implemented method of claim 1, wherein the vector representations are positioned in the vector space such that words that share a common context in the textual data are located in close proximity to one another in the vector space.

7. The computer-implemented method of claim 1, wherein the textual data includes multiple languages.

8. The computer-implemented method of claim 1, wherein the textual data includes symbols, and wherein each of the symbols represents a word or a concept, represented by vector space embeddings.

9. The computer-implemented method of claim 1, comprising:
before determining the normalized sum, consolidating the clusters; and
matching each of the consolidated clusters to a label.

10. The computer-implemented method of claim 9, comprising providing the consolidated clusters to a fully connected activation layer and to an output layer for both training.

11. The computer-implemented method of claim 1, wherein the application is deployed to a client device.

12. The computer-implemented method of claim 1, wherein the textual data is received as a corpus or a specification.

13. One or more non-transitory computer-readable storage media coupled to one or more processors and having instructions stored thereon which, when executed by the one or more processors, cause the one or more processors to perform operations comprising:
receiving textual data from an application;
processing the textual data through a trained neural network to generate a vector space of an n-dimensional shape, wherein each unique word in the textual data is assigned a corresponding vector representation in the vector space, wherein the vector space includes clusters of the vector representations for the unique words in the textual data that are synonymous;
determining a normalized sum based on the vector representation in the vector space, wherein the normalized sum represents a full dimensionality of the textual data or document; and
providing, to the application, a contextual meaning for the textual data based on the normalized sum through a simple neural network classification.

14. The one or more non-transitory computer-readable media of claim 13, wherein each of the vector representations comprise a floating point number.

15. The one or more non-transitory computer-readable media of claim 13, wherein the neural network is a shallow, two-layer neural networks having been trained to reconstruct linguistic contexts of words.

16. The one or more non-transitory computer-readable media of claim 13, wherein the vector representations are positioned in the vector space such that words that share a common context in the textual data are located in close proximity to one another in the vector space.

17. The one or more non-transitory computer-readable media of claim 13, wherein the textual data includes multiple languages.

18. The one or more non-transitory computer-readable media of claim 13, wherein the textual data includes symbols, and wherein each of the symbols represents a word or a concept.

19. The one or more non-transitory computer-readable media of claim 13, the operations comprising:
before determining the normalized sum, consolidating the clusters;
matching each of the consolidated clusters to a label; and
providing the consolidated clusters to a fully connected activation layer and to an output layer for both training.

20. A textual classification system, comprising:
one or more processors; and
a computer-readable storage device coupled to the one or more processors and having instructions stored thereon which, when executed by the one or more processors, cause the one or more processors to perform operations comprising:
receiving textual data from an application;
processing the textual data through a trained neural network to generate a vector space of an n-dimensional shape, wherein each unique word in the textual data is assigned a corresponding vector representation in the vector space, wherein the vector space includes clusters of the vector representations for the unique words in the textual data that are synonymous;
determining a normalized sum based on the vector representation in the vector space, wherein the normalized sum represents a full dimensionality of the textual data or document; and
providing, to the application, a contextual meaning for the textual data based on the normalized sum through a simple neural network classification.
